(19) United States
(12) Patent Application Publication
(10) Pub. No.: US 2007/0015009 A1
(43) Pub. Date: Jan. 18, 2007

(54) Insulating board with bentonite

(76) Inventor: Bryant McGroarty, Naples, FL (US)

Correspondence Address: WESTMAN CHAMPLIN & KELLY, P.A., SUITE 1400, 900 SECOND AVENUE SOUTH, MINNEAPOLIS, MN, 55402-3319, US

(21) Appl. No.: 11/523,233

(22) Filed: Sep. 19, 2006

Related U.S. Application Data
(63) Continuation-in-part of application No. 10/886,996, filed on Jul. 8, 2004.
(60) Provisional application No. 60/751,842, filed on Dec. 20, 2005.
(60) Provisional application No. 60/797,590, filed on May 4, 2006.

(51) Int. Cl. B32B 9/00

(52) U.S. Cl. 428/701

(57) ABSTRACT

The present invention includes a system for insulating and waterproofing wall structures, floors and roofs. A plurality of bentonite clad extruded expanded polystyrene sheets, each extruded expanded polystyrene sheet having a bentonite clad major surface and bentonite clad side surfaces are positioned such that the side surfaces form water resistant seals between adjacent extruded expanded polystyrene sheets. When used to waterproof a wall structure, the major bentonite clad surface of the extruded expanded polystyrene sheets faces the exterior wall surface of the wall structure. When used in a floor construction, the bentonite clad major surface faces upwardly and is in contact with the cementitious layer of floor material positioned on top of the extruded expanded polystyrene sheets. In a roof construction, the extruded expanded polystyrene sheets are disposed on a base roof layer with the bentonite clad major surface facing upwardly and being disposed in contact with a layer of roofing membrane.

### CROSS-REFERENCE TO RELATED APPLICATION

The present application is based on and claims the benefit of U.S. provisional patent application Ser. No. 60/751,842, filed Dec. 20, 2005, the content of which is hereby incorporated by reference in its entirety and Ser. No. 60/797,590, filed May 4, 2006, the content of which is hereby incorporated by reference in its entirety.

The present application is a continuation-in-part of and claims priority of U.S. patent application Ser. No. 10/886,996, filed Jul. 8, 2004, the content of which is hereby incorporated by reference in its entirety.

### BACKGROUND OF THE INVENTION

The present invention relates to bentonite coated extruded polystyrene insulating boards that both insulate and waterproof a structure. More specifically, the present invention relates to a bentonite coated insulating board system that forms a waterproof seal while providing insulation all in a single installation.

The universal uses of high quality insulation in the construction industry became common in the 1950's and came to fruition with the common use of air conditioning. As with most new usage, the incorporation of the new insulation caused unforeseen problems to develop as the uses diversified and challenged common practices.

The insulation materials, common at that time, included primarily cellulose (paper) and fiberglass. Polymer foams, such as urea-formaldehyde, polyurethanes and styrene beads, among others, entered the scene and produced insulation values far exceeding the fiberglass and cellulose products that they replaced.

These new products brought their own type of problems because none proved resistant enough to water for use in moist or wet conditions. The styrene beads soaked up water while the urethanes were degraded due to the presence of water. As a result, much of their insulating values were lost.

Extruded polystyrene insulation is now in common use for insulating the exterior of foundation walls and other concrete structures. Extruded polystyrene foam is made through an extrusion process in which polystyrene is processed through an extruder and an appropriate amount of a blowing agent, typically gas is added to produce a closed cell foam. Extruded polystyrene foam is distinguished from expanded polystyrene beads by its monolithic structure and its impermeability to water in an exterior environment. In contrast, expanded polystyrene beads are formed by placing in a mold beads of polystyrene having an expanding agent. Heat generally in the form of steam is injected into the mold causing the polystyrene to soften and causing the expanding agent to give off gas and expand the polystyrene beads to the capacity of the mold. The individual polystyrene beads are heated to a temperature sufficient to cause adherence of the polystyrene beads to each other to form the molded product. The expanded polystyrene beads do not lose their physical wall boundaries and therefore, the expanded polystyrene bead structure when formed into a molded product shows individual bead boundaries. Such expanded polystyrene bead product is characterized by breaking along individual polystyrene bead boundaries to produce clumps of polystyrene expanded beads or even individual beads that break free from the structure. Typically, such expanded polystyrene when used as insulation can only be used to insulate the interior of a building structure. When such expanded polystyrene bead boards are used as an insulator along the exterior of a home, the bead boundaries in the board permit water penetration and travel through the board and over time such board will deteriorate along those boundaries. Other uses of expanded polystyrene beads include forming disposable products such as polystyrene cups or expanded polystyrene packing material.

Extruded polystyrene on the other hand is a monolithic structure that is not easily broken as expanded polystyrene bead board, and if broken, is not characterized by breaking along bead boundaries since no bead boundaries exist. One example of extruded polystyrene insulation is sold under the trademark of STYROFOAM® under a distinctive blue color by the Dow Chemical Company.

Although the use of extruded polystyrene has provided a way of insulating exterior walls, because the extruded polystyrene board is attached in a series of individual boards, water travels between the adjacent boards along the sides of the boards to the exterior wall. The water then finds its way between the styrene board and the wall providing a path for heat to be conducted away from the wall thereby removing some of the insulative value of the styrene board.

There are a number of patents that describe the use of bentonite in board material intended for waterproofing. These patents include the following: White U.S. Pat. Nos. 5,389,166, 5,237,945, 5,174,231, 5,346,565 and 5,346,566; Alexander U.S. Pat. Nos. 5,063,100, 5,053,265, 5,180,255, 5,187,915 and 5,112,665; Heerten U.S. Pat. Nos. Re 37,295 and 5,221,568; Starita et al. U.S. Pat. No. 5,725,942; Byrd U.S. Pat. No. 5,580,630; Kangas U.S. Pat. No. 5,473,848; Clem U.S. Pat. Nos. 4,467,015 and 4,501,788; Blaze U.S. Pat. No. 4,344,722; Crawford U.S. Pat. No. 4,565,468; Harriett U.S. Pat. Nos. 4,656,062 and 4,787,780; Shbakhman et al. U.S. Pat. No. 4,581,868; Randall U.S. Pat. No. 4,879,173; Klatt et al. U.S. Pat. No. 6,342,088; Weaver U.S. Pat. No. 3,943,032; McGroarty et al., U.S. Pat. Nos. 4,693,923, 5,079,088 and 5,091,234; McGroarty U.S. Pat. No. 4,837,085; and McGroarty U.S. Pat. No. 5,376,429.

### SUMMARY OF THE INVENTION

The present invention includes a system for insulating and waterproofing walls, floors and roofs. A plurality of bentonite clad extruded expanded polystyrene boards, each extruded expanded polystyrene board having a bentonite clad major surface and bentonite clad side surfaces, are positioned such that the side surfaces form water resistant seals between adjacent extruded expanded polystyrene boards.

When used to waterproof a wall structure, the major surface of the extruded expanded polystyrene boards faces the exterior wall surface of the wall structure. When used in a floor construction, the bentonite clad major surface faces upwardly and is in contact with the cementitious layer of floor material positioned on top of the extruded expanded polystyrene boards. In a roof construction, the extruded expanded polystyrene boards are disposed on a base roof layer with the bentonite clad major surface facing upwardly and being disposed in contact with a roof membrane.

### BRIEF DESCRIPTION OF THE DRAWINGS

FIG. 1 is a perspective view of a waterproofing insulating board of the present invention.

FIG. 2 is a perspective view illustrating waterproof seals that form between insulating boards and on the surface of an exterior vertical wall when a plurality of insulating boards are secured to the vertical basement wall.

FIG. 3 is a perspective view also illustrating a waterproof seal that is formed when bentonite-coated insulating boards are included as part of a concrete floor.

FIG. 4 is a cross-sectional perspective view of two adjacent bentonite coated insulating boards placed under a roof membrane that is positioned over the insulating boards using a rock ballast.

FIG. 5 is a perspective view of a roof structure illustrating the use of fluorescent material.

FIG. 6 is a perspective view illustrating the use of bentonite-coated insulating boards during construction of concrete buildings.

### DETAILED DESCRIPTION

The present invention generally relates to a bentonite-coated extruded polystyrene insulating board for use in wall, floor and roof structures. The bentonite coating forms a waterproof seal in the presence of water and enables waterproof sealing of the structure to which the bentonite-coated insulating board is incorporated. The insulating board of the present invention provides a means for insulating and waterproofing in one step resulting in large savings of labor costs. In providing a substantially complete seal, the bentonite-coated insulating board prevents water migration and/or penetration therefore limiting the availability of moisture, controlling mold, odor, and condensation within a building structure.

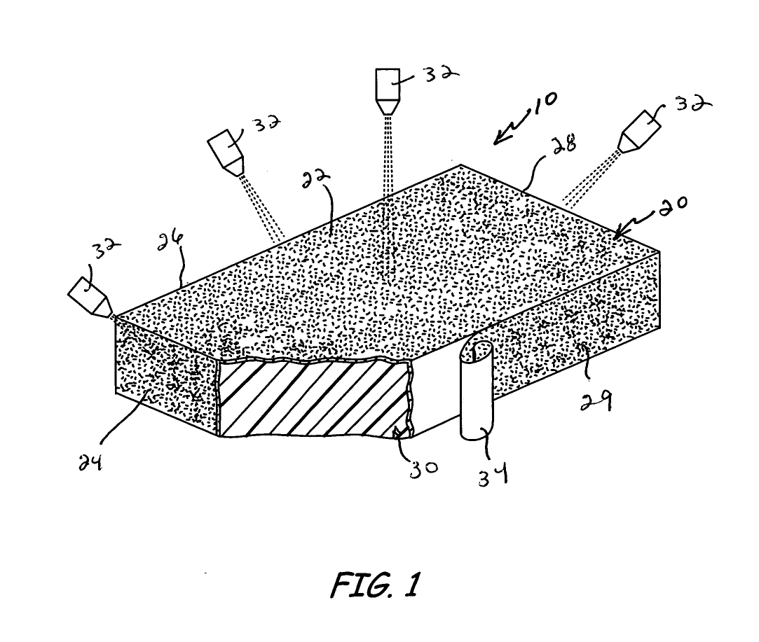

A waterproofing insulating board of the present invention is generally depicted at 10 in FIG. 1. The waterproofing insulating board 10 comprises a coating 20 of bentonite that is adhered preferably directly to an extruded expanded polystyrene insulating board 30. The insulating board 30 may be clad with bentonite using a number of different methods as is discussed infra. Like reference characters will be used to indicate like elements throughout the FIGS. 1 to 6. The bentonite coating 20 is approximately one half the weight of previous bentonite waterproofing membranes which permits installation of the board 10 without the use of nail guns or concrete nails due to its decreased weight. The board 10 can be installed on vertical walls using adhesives rather than nails. Bentonite granules cover the board 10 on a major surface 22 and four side surfaces 24, 26, 28 and 29 that are generally perpendicular to the major surface 22.

The thickness of the bentonite coating 20 of the waterproofing insulating board generally ranges from about one-eight (⅛) inch to about one-fourth (¼) inch when practicing the present invention. Furthermore, a thickness that is less than ⅛ inch or greater than ¼ inch may also be used to form the waterproofing insulating board 10. In addition, the bentonite coating ranges from about 0.5 to about 0.70 lbs. per square foot.

Conventional dimensions for extruded expanded polystyrene insulating board are 8 feet by 4 feet by 1 to 2 inches thick. Polystyrene board is also made in various widths, lengths and thicknesses. A conventional insulating board is 8 feet by 4 feet by 1 inches thick.

Currently, extruded polystyrene insulation is typically installed in boards to exterior surfaces of subterranean or basement walls to help insulate buildings. For purposes of this application, the terms “boards” and “sheets” will be used interchangeably both meaning a piece of material considerably greater in length and breadth when compared to thickness and having a degree of stiffness such that it resists being easily folded on itself. When polystyrene insulation boards are installed to the exterior of a basement wall, several problems can arise. For example, melting snow or ice can travel between and under the insulation boards. As a result, the traveling water wets the exterior wall and destroys some of the insulative value of the polystyrene since the water acts as a heat conductor. Wet outer walls create an interior building environment conducive to mold growth.

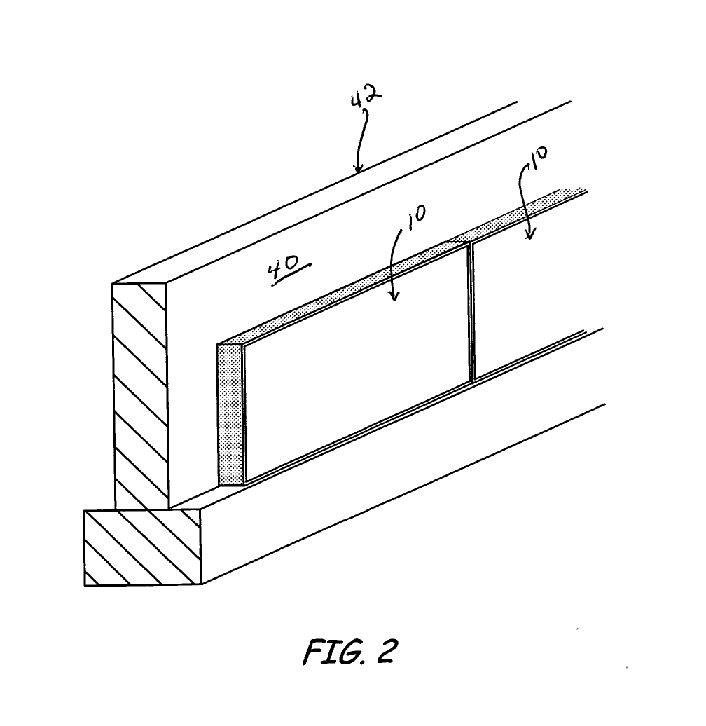

To address the challenges of using insulation on the outside surface 40 of a vertical wall 42, a plurality of bentonite-coated insulating boards 10 of the present invention are installed to the outside surface 40 of an outside vertical wall, as best depicted in FIG. 2. The bentonite-coated insulating polystyrene extruded boards 10 are the same construction as discussed with respect to FIG. 1. The insulating boards 10 include one major surface coated with bentonite and all four side surfaces of the polystyrene board coated with bentonite. The bentonite-coated insulating boards 10 are placed adjacent each other with the bentonite coated surface facing the exterior concrete surface 40 of the vertical wall 42. The bentonite coated insulated boards 10 are secured to the outside surface 40 of the vertical wall by a suitable adhesive as discussed infra. Upon water reaching the polystyrene board, a waterproof seal is formed along the perimeter (side) of each board 10. The bentonite coating along the sides of adjacent insulating boards hydrates and expands forming a seal between the adjacent insulating boards. If water were to get past the seal, or the polystyrene board becomes damaged such as by a puncture, the bentonite along the major surface facing the exterior surface 40 of the concrete will also hydrate and form a waterproof seal. Thus insulation and a water seal are provided in one application greatly reducing labor costs. In addition, since the insulation is on the exterior surface, interior room space is increased resulting in space savings.

The present invention may be also used to insulate a concrete floor, whether that concrete floor is a ground level concrete slab or the concrete slab of a basement. Moisture is typically “pumped” to the surface of a concrete floor by capillary draw or capillary attraction. Installation of insulation under floor slabs has been abandoned because current waterproofing and insulation products cannot keep the wet or cool dampness of the earth underlayment from creating a cold surface on the basement concrete floors. Therefore, homeowners have had to install a false floor covering the cold concrete floor if a warm floor is desired or install a heating element(s) in the concrete floor. In addition, any time a cool surface is present, the predisposition for condensation of water vapor is present. In a basement, condensation creates an environment for molds, odor and allergens.

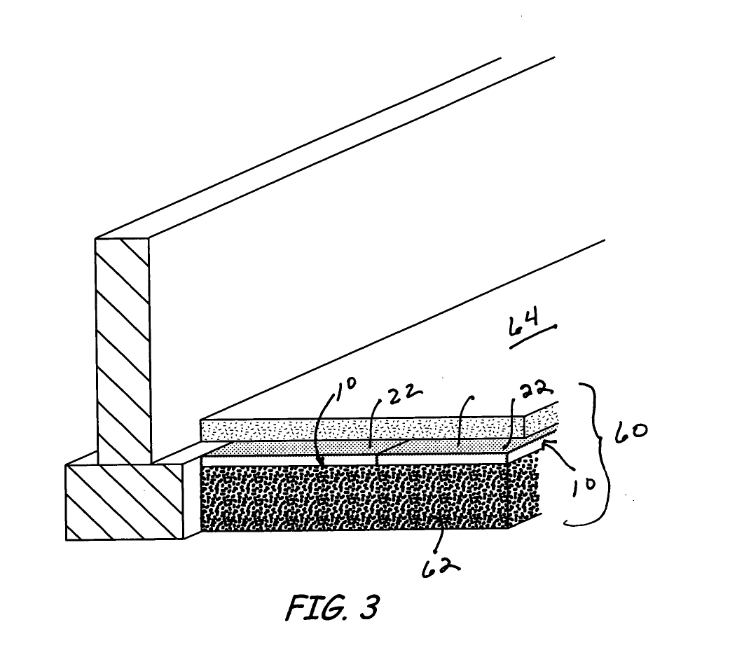

A plurality of bentonite coated polystyrene insulating boards 10 as described with respect to claim 1 are included as part of a floor structure 60 as best depicted in FIG. 3. Bentonite-coated insulating boards 10 are installed adjacent each other with bentonite coated sides facing and touching sides of adjacent boards 10. The insulating boards 10 are placed typically on a base layer such as gravel 62 with the major bentonite coated surface 22 facing upward. Next, concrete is poured onto the bentonite coated boards 10 and hardens to form a continuous concrete floor in which the bentonite coating of the insulating board touches the bottom surface of the concrete floor 64. Water is kept from the concrete floor since the bentonite on the sides of adjacent insulating boards will expand thereby sealing off any path that water can take between the insulating boards. In addition, since bentonite is also present on the surface facing the concrete floor, any water seepage that may get through will be absorbed and further stopped by the expansion of the bentonite on the surface facing the concrete floor. Since water is not allowed to penetrate to the concrete floor, water as a heat conductor is eliminated, thereby allowing the insulative board to insulate the concrete floor to maintain the concrete floor at a warmer temperature.

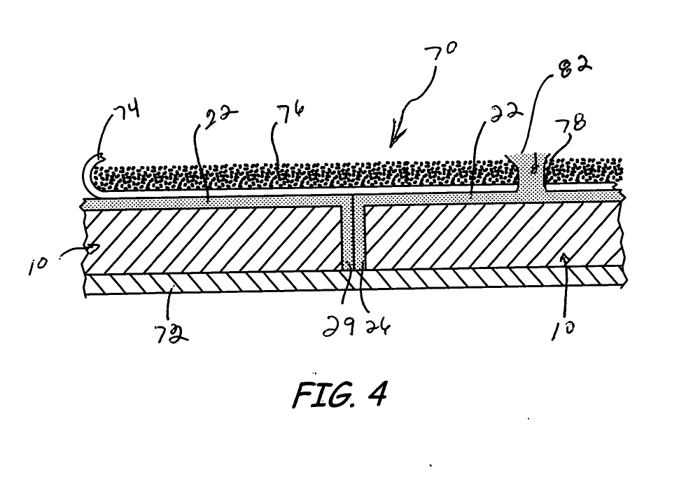

The present invention may also be used to insulate a flat roof 70, as illustrated in FIG. 4. Typically, a flat roof 70 is a composite type of roof having a sub-roof layer 72 on which insulation is positioned. In the present invention, insulating boards 10 such as those described with respect to FIG. 1 are positioned on the sub-roof layer 72. A membrane 74, typically in the form of a polymer sheet, is disposed on the insulation. Gravel typically in the form of rounded pebbles ballast is placed on the membrane to hold the membrane in position. There are many variations to flat roofs but the above described elements are typically the basic elements for such composite flat roofs.

A common problem with flat roofs is that when the membrane 74 is punctured, water is permitted to seep through the membrane and migrate past the insulation thereby reducing the insulative value of the insulation, but also damage to the sub-roof layer 72 and the building structure positioned therebelow. Such membrane punctures or leaks are hard to find, and therefore costly to repair since typically the entire roof must be replaced in order to ensure that the leak has been eliminated.

The bentonite coated insulating boards of the present invention provide a method of stopping leaks when the membrane is punctured. The insulating boards 10 are positioned on the sub-layer 72 in an adjacent manner with side edges 29 and 26, both coated with bentonite, facing each other. In addition, each insulating board's major surface 22 is positioned upwardly to face the membrane 74. The rock ballast 76 holds the membrane 74 against the major surfaces 22 of the insulating boards 10. If a leak 78 develops in the membrane 74, the bentonite coating will swell up against the membrane to restrict water migration through the membrane down to the sub-roof layer. In addition, the sides 29 and 26 of adjacent insulating boards 10 will also swell to form a seal so that no further water will be able to migrate between the roof membrane and the insulation.

To aid in locating a puncture in the membrane, a fluorescent material is added to the bentonite coating when the coating is applied to the styrene board. When a fluorescent material is exposed to ultraviolet light, it will fluoresce. The fluorescent material incorporated into the coating is derived from fluorescent minerals such as fluorite, hackmanite, sodalite, meionite, and other similar fluorescent bearing minerals, freeze-thaw stable fluorescent dyes and the like. The fluorescent mineral is distributed throughout the bentonite coating or can be applied as a top coating to the major surface 22. Consequently, the hole in the roof membrane is sealed by the expanded bentonite while at the same time identifying the location of the hole.

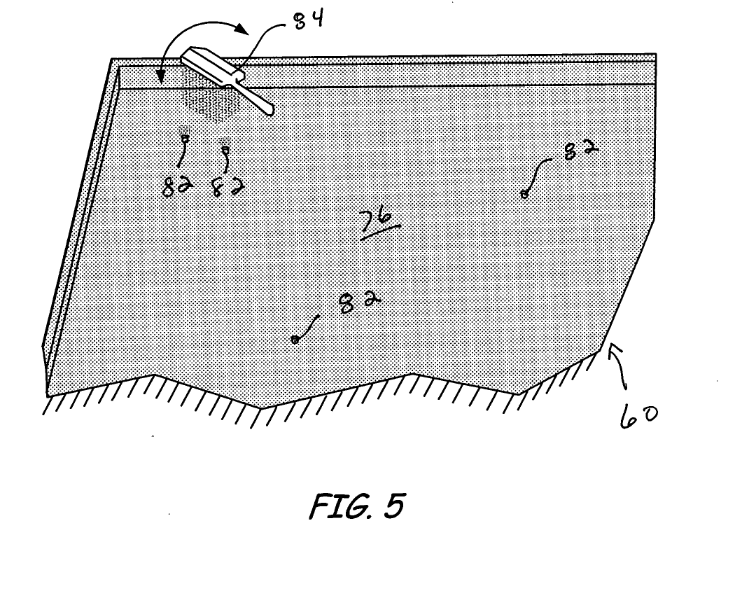

As a leak develops in the membrane, the bentonite 82 in the coating hydrates and expands above the surface of the membrane in response to water leakage as illustrated in FIG. 5. The expansion of the bentonite forces bentonite through the hole in the membrane. Since bentonite is capable of swelling up to 18 times its dry volume, sufficient expansion will occur beyond the outer surface of the membrane exposing the bentonite. The exposure of the bentonite above the membrane surface provides a method for locating punctures in the membrane. Since fluorescent material responds to ultraviolet radiation, the use of a black light 84 after dark will readily result in the expanded bentonite showing within the gravel ballast 76 of the roof 60. The locations of the fluoresced material can then be marked so that repairs can be done.

Extruded foamed polystyrene insulation forms are increasingly being used to construct concrete buildings and houses to lower costs. Lower costs are anticipated because wooden forms do not have to be used for forming concrete walls and the like. In addition, the extruded foamed insulation, once the concrete is cured, forms part of the concrete wall.

Briefly, when using extruded foamed insulation as part of a concrete wall, two sheets of insulation are vertically installed and spaced apart to form generally parallel walls which are used subsequently for filling with concrete to form the exterior wall. After the concrete cures, the insulation remains on the exterior and interior surface of the wall. Conventional waterproofing material is then applied to the insulation located on the exterior portion of the wall. However, water migration can still occur since the extruded polystyrene is applied in sheets, and water can still leak or find its way to the concrete between adjacent sections of polystyrene.

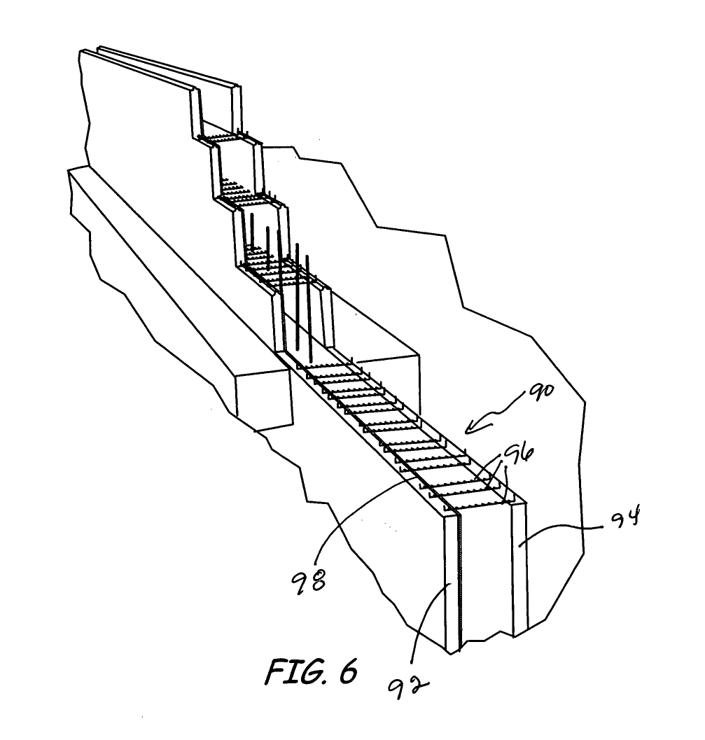

As illustrated in FIG. 6, the extruded polystyrene insulated concrete forms 90 include an exterior expanded polystyrene wall form 92 and an interior expanded polystyrene wall form 94. The wall forms 92 and 94 are held in generally parallel relationship by transversally disposed brackets 96. A bentonite coating 98 is secured to the exterior wall form to face the to-be-formed concrete wall.

After the concrete is poured and cured, the bentonite coating on the wall form 94 facing the outside surface of the concrete wall forms a barrier that prevents water migration from the outside to the concrete wall. The bentonite coating expands to seal off water movement and prevents water from passing between styrene sheet sections and under the styrene insulation. As a result, water leakage is prevented from passing through the concrete wall and dampening the interior wall surface of the building.

Alternatively, the use of bentonite-coated insulating boards is also applicable to pre-cast foundations and wall panels that are commonly used in the construction industry to save time and money during construction. In this embodiment, the insulating boards are attached to the pre-case foundations and wall panels as discussed with respect to FIG. 2. The insulating boards when attached to the pre-cast foundation and walls form waterproofing seals between each insulating board as well as on the surface of the board thus waterproofing and insulating in one application.

The waterproofing insulating board 10 is generally formed by coating or wetting an extruded polystyrene insulating board or sheet with an adhesive. The adhesive is deposited onto a surface of the board until an entire surface of the board 30 is covered with the adhesive to form a coated board. Typically, deposition of the adhesive proceeds until the major surfaces 22 and the four side surfaces 24, 26, 28 and 29 of the board 30 are coated with the adhesive. Alternatively, the insulating board can be dipped into the adhesive until the horizontal surface and 4 vertical edges are coated with the adhesive.

Next, the adhesive coated surfaces of the insulating board are pressed into dry granular bentonite so that a layer of bentonite adheres to the adhesive coated surfaces. Any loose bentonite is removed and the process of pressing the insulating board into the dry granular bentonite is repeated until the desired thickness of bentonite is attained. Alternatively, a mixture of bentonite and adhesive is sprayed directly onto the surfaces of the insulating board to coat the insulating board with bentonite and form a bentonite coated insulating board.

In another embodiment, a mixture of bentonite and an adhesive that is capable of adhering bentonite to the surface of an insulating board is sprayed as depicted by sprayers 32 onto the horizontal top surface of a vibrating insulating board that is positioned in an approximately 30 to 70 degree angle from a horizontal plane. The vibration allows a lower angle to be used while facilitating the removal and/or repositioning of any loose bentonite particles during spraying. In addition, the vibration increases the rate and percentage of deposited bentonite since any loose bentonite particles slide off and leave a “stuck down” layer of bentonite to which the next layer of bentonite and adhesive can adhere. The mixture of bentonite and adhesive are deposited onto the surface of the insulating board until at least about 0.50 to about 0.70 lbs per square foot is attained.

In yet a further embodiment, bentonite may also be sprayed onto a fabric (as illustrated by reference character 34 in FIG. 1) that is subsequently adhered to the extruded expanded polystyrene board. In general, any porous woven layer derived from natural or synthetic material that is readily permeable to water and dimensionally stable in at least two directions is suitable for use as the fabric when practicing the present invention. The fabric is typically porous enough to retain bentonite embedded into the fabric yet tight enough to stop bentonite particles from passing through. In an example, the fabric may comprise approximately 10% hole area of the total surface area of the fabric.

In still another embodiment, bentonite may be included as part of a thin membrane that is adhered to the insulating board 30 using an adhesive. When the bentonite is included as part of a thin membrane, the membrane may have a 4-layer structure. The 4-layers include a support layer, first and second flexible compressed bentonite layers and a water-permeable thin flexible membrane disposed between the two bentonite layers. Although each of the layers is distinct, the layers are integrated with each other to form the membrane.

The first bentonite layer is generally located on top of, and within the support layer. In general, any porous woven layer derived from natural or synthetic material that is readily permeable to water and dimensionally stable in at least two directions is suitable for use as the support layer of the 4 layer bentonite when practicing the present invention. The support layer is typically porous enough to retain bentonite embedded into the support layer yet tight enough not to permit bentonite particles to pass through.

Next, the thin flexible membrane disposed between the first and second bentonite layers may be water-permeable or water-impermeable. When the thin flexible membrane is water-permeable, the membrane is typically woven, braided or perforated to allow water to access the bentonite layers. In addition, the thin flexible membrane is typically flexible or elastic enough to allow the membrane to be folded upon itself or bent about 360° or bent to approximately a 0.5 inch radius.

A bentonite-adhesive composition may also be included that adheres the bentonite particles to each other, and the bentonite particles to the fabric. The bentonite-adhesive composition is typically sprayed onto the bentonite particles prior to compression in an amount that typically ranges from about 10 weight percent to about 30 weight percent of the bentonite particles. During compression, the bentonite-adhesive composition binds the bentonite particles in a fibrous adhesive matrix to form an amalgamate structure.

In general, any adhesive that (1) does not affect the water-absorbing and gelling properties of the bentonite to any great degree, and is (2) flexible and/or elastomeric when the adhesive is cured or dried is suitable for use as the bentonite-adhesive composition for this embodiment. For adhering the bentonite particles directly to the extruded expanded polystyrene board, any suitable adhesive that binds the bentonite particles is suitable. Some non-exhaustive examples of suitable adhesives include water-soluble adhesives, such as saccharides, gums, tars, proteins, cellulosics or any combination of any of these, styrene, butadiene, urea/formaldehyde, acrylics, nitrites, asphalts, butyl and natural rubbers, non-pressure sensitive acrylics, vinyl acetate, vinyl acetate copolymer, alkyds, epoxy, fluorocarbons, phenolic compounds, polyester, polyethylene, and any combination of any of these. Additionally, the bentonite-adhesive may further comprise a solvent for effective delivery. Some non-exhaustive examples of suitable solvents for the bentonite-adhesive composition include aliphatic compounds, ketones, aldehydes, carbon/halides, toluene and other ring compounds and alcohols. Other methods of depositing or coating bentonite particles onto the top horizontal and four vertical surfaces may also be used when practicing the invention.

The adhesive composition is generally about 5 to about 30 weight percent, based on the total weight of the bentonite. When the adhesive composition contains a solvent, the solvent must not dissolve the bentonite or the polystyrene insulating board 30. Therefore, the solvent used to form the adhesive composition should generally not include aromatic or chlorinated hydrocarbons, ketones, acetones, esters, furans, volatile organic compounds (VOCs), such as hydrocarbon with a vapor pressure equal or greater than 0.1 mm mercury (Hg), any fatty acid ester, or any combination of any of these.

When the bentonite is in a liquid mixture, the mixture comprises bentonite, a solvent, and a bentonite-adhesive composition to hold the bentonite together. To form the mixture, the bentonite, solvent and the bentonite-adhesive composition homogeneously are mixed together in a mixing apparatus (not shown) to form a homogeneous mixture. Typically, the bentonite has a particle size that is less than 20 mesh and larger than 200 mesh (US Standard mesh size) when forming the mixture. In addition, the bentonite adhesive is added at a concentration that is about 10 weight percent to about 30 weight percent of the mixture.

Furthermore, an organic solvent may be included as part of the mixture to control the viscosity and enable extrusion if needed. Solvents that attack the polystyrene insulating board 30 are generally considered to be unsuitable for use when forming the mixture and therefore, such solvents are to be avoided. As examples, ketones, furans and aldehydes should be avoided when forming the mixture. On the other hand, low to medium molecular weight alcohols are suitable for use as the solvent.

The bentonite particles may be derived from sodium montmorillonite or a combination of sodium montmorillonite and calcium montmorillonite. Typically, the bentonite is derived from sodium montmorillonite in a particle size that is less than 20 meshand larger than 200 mesh. Bentonite particles having a low free silica content, a moisture content of less than about 5% by weight, and particle sizes less than 20 meshand larger than 200 meshcan be used to practice the present invention.

In another embodiment, the bentonite particles may be compressed to the desired particle size of smaller than 100 mesh. As an example, the bentonite particles are compressed with a force of between about 1 pound per square inch and about 200 pounds per square inch. Typically about 20 pounds per square inch and 100 pounds per square inch are used to compress the bentonite particles when practicing the present invention. Compressed bentonite particles allow for a reduced amount of bentonite particles to be used to form a waterproofing layer on the insulating board since compressed bentonite allows for close packing of bentonite particles, and subsequently, reduced water permeability of the bentonite layer. In addition, less bentonite is needed to form a water seal since the bentonite does not have to expand as much to fill any voids between bentonite particles.

Although the present invention has been described with reference to preferred embodiments, workers skilled in the art will recognize that changes may be made in form and detail without departing from the spirit and scope of the invention.

What is claimed is:

1. A system for insulating and waterproofing a building structure, the system comprising:
a plurality of bentonite clad extruded expanded polystyrene sheets, each extruded expanded polystyrene sheet having a bentonite clad major surface and bentonite clad side surfaces, the bentonite clad extruded expanded polystyrene sheets being arranged such that the bentonite clad side surfaces are positioned to form water resistant seals between adjacent extruded expanded polystyrene sheets.

2. The system of claim 1 wherein the building structure is a wall having an exterior facing surface and the bentonite clad major surface faces the exterior facing surface of the wall.

3. The system of claim 1 wherein the bentonite is directly coated and adhered to the extruded expanded polystyrene sheets.

4. The system of claim 1 wherein the building structure includes a floor having a cementitious upper floor layer and wherein the bentonite clad major surface of the extruded expanded polystyrene sheets are facing upward in engagement with a lower surface of the cementitious floor layer.

5. The system of claim 1 wherein the building structure includes a roof having a roofing sub-layer and a top layer and wherein the bentonite clad major surfaces of the extruded expanded polystyrene sheets are positioned to face the upper roof layer.

6. A building structure comprising:
a wall having an exterior facing surface; and
a plurality of bentonite clad extruded expanded polystyrene sheets, each extruded expanded polystyrene sheet having a bentonite clad major surface and bentonite clad side surfaces, the extruded expanded polystyrene sheets being secured to the wall structure with the bentonite clad major surface facing the wall structure and the extruded expanded polystyrene sheets being arranged such that the bentonite clad side surfaces are positioned to form water resistant seals between adjacent extruded expanded polystyrene sheets.

7. The building structure of claim 6 wherein the wall comprises a cementitious material.

8. The building structure of claim 6 wherein the bentonite clad major surface of the extruded expanded polystyrene sheets is directly coated to the expanded polystyrene sheets.

9. The building structure of claim 6 wherein the bentonite clad extruded expanded polystyrene sheets are adhesively secured to the wall.

10. A floor structure disposed on a ground layer comprising:
a plurality of extruded expanded polystyrene sheets, each expanded extruded polystyrene sheet having a bentonite clad major surface and bentonite clad side surfaces, the expanded extruded polystyrene sheets being disposed on the ground layer with the major bentonite clad surface facing upwardly and the extruded expanded polystyrene sheets being arranged such that the bentonite clad side surfaces are positioned to form water resistant seals between adjacent polystyrene sheets; and
a floor layer disposed on the major bentonite clad surface of the plurality of bentonite clad extruded polystyrene sheets.

11. The floor structure of claim 10 wherein the floor layer comprises a cementitious material.

12. The floor structure of claim 10 wherein the bentonite is directly coated on to the extruded polystyrene sheet.

13. A roof construction comprising:
a roof sub-layer;
a plurality of bentonite clad extruded expanded polystyrene sheets, each extruded expanded polystyrene sheet having a bentonite clad major surface and bentonite clad side surfaces, the extruded expanded polystyrene sheets being disposed on the roof sub-layer with the bentonite clad major surface facing upwardly and the extruded expanded polystyrene sheets being arranged such that the bentonite clad side surfaces are positioned to form water resistant seals between adjacent extruded expanded polystyrene sheets;
a top roof layer positioned on the bentonite clad major surfaces of the plurality of bentonite clad extruded expanded polystyrene sheets.

14. The roof construction of claim 13 wherein the top roof layer comprises a flexible membrane positioned directly over the bentonite clad major surfaces of the extruded expanded polystyrene sheets and a ballast layer disposed on the membrane.

15. The roof construction of claim 11 wherein the bentonite clad major surface includes a fluorescent component.

16. The roof construction of claim 13 wherein the bentonite is directly coated to at least the major surface of the extruded expanded polystyrene sheets.

17. A concrete form structure comprising:
first and second form walls wherein at least one of the form walls comprises extruded expanded polystyrene, the form walls being spaced from each other a distance sufficient for accepting concrete therebetween and for permitting concrete to cure to form a concrete wall structure, the extruded expanded polystyrene sheets have a bentonite coating on a surface for facing concrete.

18. The concrete form structure of claim 17 wherein the first form wall is used to form an exterior surface of the concrete wall structure and the expanded polystyrene sheet with the bentonite coating is part of the first form wall.

19. The form wall of claim 17 wherein both first and second form walls comprise extruded expanded polystyrene sheets.
